(19) United States
(12) Patent Application Publication
(10) Pub. No.: US 2021/0027644 A1
(43) Pub. Date: Jan. 28, 2021

(54) METHOD AND SYSTEMS FOR PROVIDING EDUCATIONAL SUPPORT

(71) Applicant: Learning Innovation Catalyst, LLC, Washington, DC (US)

(72) Inventors: Tiffany WYCOFF, Sausalito, CA (US); Jason GREEN, Washington, DC (US); Jaime PALES, San Juan, PR (US)

(21) Appl. No.: 16/938,437

(22) Filed: Jul. 24, 2020

Related U.S. Application Data
(60) Provisional application No. 62/879,267, filed on Jul. 26, 2019.

(51) Int. Cl. G09B 5/12; G09B 7/02; G09B 5/06; G09B 5/14; H04L 9/06

(52) U.S. Cl. CPC G09B 5/12; G09B 7/02; H04L 9/0637; G09B 5/14; G09B 5/065

(57) ABSTRACT

The disclosure provides a professional development system for facilitating continuing education and credentialing. The professional development system includes an interactive computer system for presenting a series of interfaces that guide a user through an educational cycle. For example, the system may present a dashboard to the user, the dashboard including at least one educational cycle for the user. The educational cycle may include at least a video, a pre-activity questionnaire, an activity plan template, and a post-activity questionnaire. The system may play the video to the user. The system may receive a completed pre-activity questionnaire. The system may receive a completed activity plan template. The system may receive a completed post-activity questionnaire. The system may determine that the cycle is completed in response to receiving the completed pre-activity questionnaire, the completed activity plan template, and the completed post-activity questionnaire.

This application claims priority to U.S. Provisional Application No. 62/879,267 titled “METHOD AND SYSTEMS FOR PROVIDING EDUCATIONAL SUPPORT,” filed Jul. 26, 2019, which is assigned to the assignee hereof, and incorporated herein by reference in its entirety.

### BACKGROUND

Professional development in the 21^{st} Century has gone from a choice that human beings used to make in order to grow and advance their careers to a required lifelong process to adapt to an exponentially growing and changing world. Agency in continuous learning is a skill that will need to be developed in students and any professional so that they can successfully implement it throughout their careers and lives. Human beings not only will have to quickly adapt their own practices to meet the needs of this rapidly changing world, but as new technology becomes more available and sophisticated, they will have to learn how use it and transform their roles to stay relevant when it replaces some of the tasks that humans used to perform.

Existing professional development resources follow a “sit and get” methodology, where learners receive lectures or written materials. There is little or no structured follow up. Organizational leaders may have no ability to monitor progress or determine whether objectives are being completed. Finally, current professional development resources do not provide the methodology or tools to provide agency to learners in their continuous development process.

Thus, there remains an unmet need in the educational field to aid learners in in continuing professional development.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, the disclosure provides a method for providing education. The method may include presenting a dashboard to a user, the dashboard including an educational cycle for the user, wherein the educational cycle includes at least a video, a pre-activity questionnaire, an activity plan template, and a post-activity questionnaire. The method may include playing the video to the user. The method may include receiving a completed pre-activity questionnaire. The method may include receiving a completed activity plan template. The method may include receiving a completed post-activity questionnaire. The method may include determining that the educational cycle is completed in response to receiving the completed pre-activity questionnaire, the completed activity plan template, and the completed post-activity questionnaire.

In another aspect, the disclosure provides a computer system for providing education. The computer system may include a server communicatively coupled to a user device via a network. The computer system may include a first graphical user interface (GUI), generated by the server and transmitted to the user device for display to a user, the first GUI including a dashboard, the dashboard including an educational cycle for the user, wherein the educational cycle includes at least a video, a pre-activity questionnaire, an activity plan template, and a post-activity questionnaire. The server may be configured to play the video to the user. The server may be configured to receive a completed pre-activity questionnaire. The server may be configured to receive a completed activity plan template. The server may be configured to receive a completed post-activity questionnaire. The server may be configured to determine that the educational cycle is completed in response to receiving the completed pre-activity questionnaire, the completed activity plan template, and the completed post-activity questionnaire.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example computer network for connecting multiple users to a professional development system.

FIG. 2 is a diagram illustrating an example computer system.

FIG. 3 is a diagram illustrating an example user interface for a user dashboard.

FIG. 4 is a diagram illustrating an example user interface for an educational cycle.

FIG. 5 is a diagram illustrating an example user interface for a pre-activity reflection.

FIG. 6 is a diagram illustrating an example user interface for an activity plan template.

FIG. 7 is a diagram illustrating an example user interface for a post cycle reflection.

FIG. 8 illustrates an example interface for showing goals on a dashboard.

FIG. 9 illustrates an example interface for showing completed badges on a dashboard.

FIG. 10 is a diagram illustrating an example user interface including a playlist of multiple educational cycles.

FIG. 11 is a diagram illustrating an example user interface for associating an education cycle with a user or organization.

FIG. 12A illustrate an example interface for configuring a user achievable goal.

FIG. 12B illustrates an example interface for configuring content for a user achievable goal.

FIG. 13 illustrates an example coaching interface for a coach to monitor users.

FIG. 14 illustrates a flowchart showing an example method for interacting with a user to complete an educational cycle.

FIG. 15 illustrates a flowchart showing an example method of interacting with an organizational leader to assign a cycle to one or more users.

FIG. 16 illustrates a flowchart showing an example method of interacting with an organizational leader to configure a goal for one or more users.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The disclosure provides an educational solution for supporting learners through a research-backed educational methodology for developing new skills and techniques. For example, the educational solution may be utilized by teachers to learn new practices and activities to be used in a classroom. In an aspect, the educational solution includes an interactive computer application system for presenting a series of user interfaces that evaluate the current practices and skills of a learner. The educational system may guide a learner through a cycle including four phases of a learning experience including an inspirational video, a pre-activity questionnaire, an activity planning template, and a post-activity questionnaire. Educational cycles may be grouped into playlists and playlists or cycles may track a roadmap for an organization. Learners may achieve goals by completing playlists and receive awards, which may be a credential in the form of an open badge or block certification. Further, the educational solution may provide coaching support throughout the educational experience.

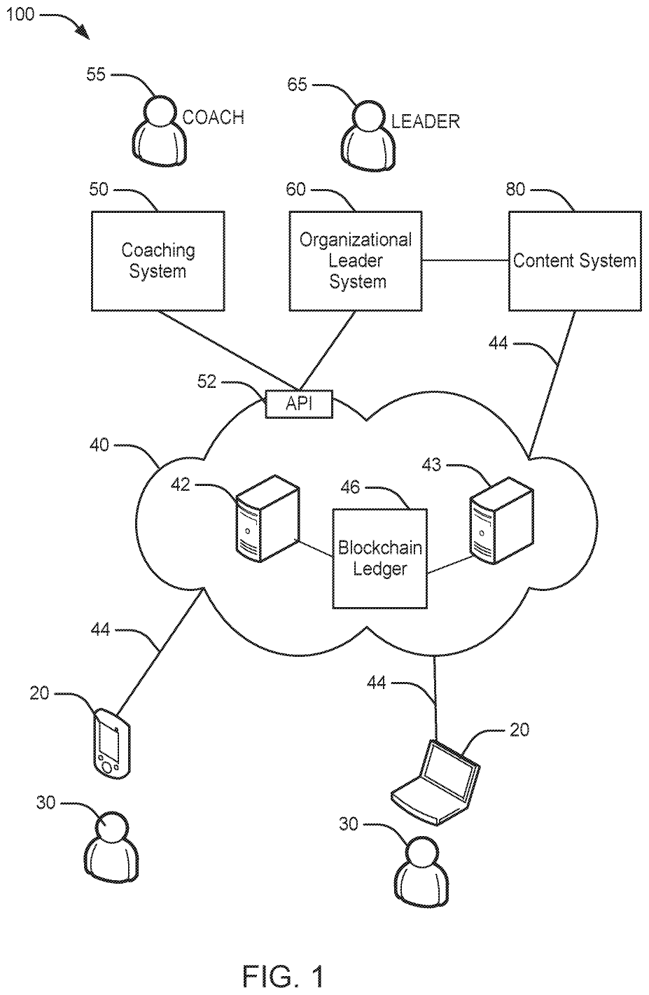

FIG. 1 illustrates an example professional development system 100 for continuing education for teachers and skills accreditation. The system 100 may be an example educational solution. Similar systems may be implemented for other learners and organizations. The system 100 may support organizational leaders to develop educational cycles for learners, such as teachers. The organizational leaders may then assign educational cycles to learners or set goals for the learners to complete the educational cycles. The system 100 may present the educational cycles to the learners, track the progress of each learner within an educational cycle, and connect learners to coaches to assist with completion of a cycle.

The system 100 may include one or more servers such as an application server 42 and a storage server 43, which may be implemented in a distributed network 40 (e.g., in the cloud). In an aspect, one or more of the servers may include a blockchain ledger 46 to publish verifiable credentials. For example, the verifiable credentials may meet open badge standards. The system 100 may include one or more user devices 20 that interact with the network 40 to provide an interface for a user 30 to interact with the system 100.

The user device 20 may be communicatively coupled to the network 40. The network 40 may include any network that allows communication between the various entities of the system 100. In an aspect, the network 40 may be a communications network and may include or be connected with other networks. For example, the user device 20 may include a modem and be coupled to the network 40 via a wired or wireless connection. The network 40 may include one or more computer servers 42. The computer servers 42 may include information for managing the system 100 including software for providing an interactive online application for the users 30. In an aspect, for example, the computer servers 42 may include application servers for interacting with user devices 20 for providing various interfaces or notification servers for providing messages to the users 30. The term “user” may refer to any person accessing the system 100. A user may be associated with a role that controls access to one or more features or a view of the one or more features. Example roles include: learner, organizational leader, coach, and administrator. In an aspect, the system 100 may include separate systems (e.g., coaching system 50 and organizational leader system 60) for users with a specific role (e.g., coach 55 and leader 65, respectively). In an aspect, a user may have more than one role. For example, a user may be both an organizational leader and a coach, or a user may be both a learner and a coach. The computer servers 42 may also include one or more web servers running web applications that may allow users 30, coaches 55, leaders 65, or administrators to interact with the system 100 in the defined roles. For example, a coaching system 50 may provide an application for coaches 55 to interact the system 100 for providing a coaching service to users 30. As another example, the organizational leader system 60 may provide an application for leaders 65 to interact with the system 100 for communicating with users 30. The system 100 may also include systems such as a content system 80 that provides educational cycles, activities, or other programming. The network 40 may also include storage servers 43 for storing user information, content, billing information, etc.

In an aspect, the application server 42 and/or the storage server 43 may include a blockchain ledger 46. The blockchain ledger 46 may make certain information publicly available and/or verifiable. For example, the blockchain ledger 46 may include a record of accomplishments of a user (e.g., cycles completed, goals met, or badges earned). In an aspect, a third-party (e.g., a principal or other school official) may access the blockchain ledger 46 to view the accomplishments of the user 30. In another aspect, the blockchain ledger 46 may allow only verification of information. For example, the system 100 may provide users 30 with a link to the blockchain ledger 46 that may be provided to others for verification of the accomplishments. The link may include a plain text version of the accomplishments and a hash (or instructions for generating a hash) that is stored in the blockchain ledger 46. For example, the user 30 may provide the link to a different organization (e.g., a new school district) that may access the blockchain ledger 46 to confirm that accomplishments listed by the user 30 have been completed. For example, the user 30 may show that the user 30 has completed required training with a different organization. In an aspect, the application server 42 may issue open badges. For example, an organizational leader may associate an open badge with a goal. When a user completes the goal, the application server 42 may award the open badge. Accordingly, the open badges may operate alternatively, or in addition to the blockchain ledger. In an aspect, for example, open badges may be awarded for completing specific playlists to demonstrate experience with a particular skill, practice, or theory. In contrast, a block certification may be awarded for completing requirements of an organization or a regulation. For instance, a block certification may be awarded when a learner qualifies to be a coach.

In one aspect of the disclosure, various data is, for example, input and/or accessed by the users 30, coaches 55, leaders 65, or other users via user devices 20 such as personal computers (PCs), minicomputers, mainframe computers, microcomputers, telephonic devices, or wireless devices, personal digital assistants (“PDAs”) or a handheld wireless devices (e.g., wireless telephones). The user devices 20 may be coupled with a computer server 42, such as a PC, minicomputer, mainframe computer, microcomputer, or other device having a processor and a repository for data and/or connection to a repository for data, via, for example, the network 40, such as the Internet or an intranet, and/or a wireless network. The couplings 44 include, for example, wired and/or wireless connections.

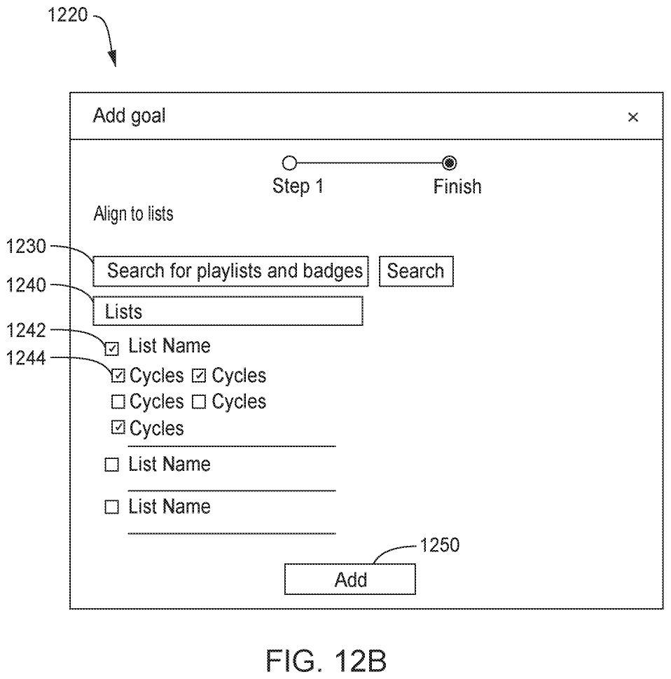

A coaching system 50 may schedule and account for live coaching sessions between a user 30 and a coach 55. The system 100 or component thereof (e.g., a server 42) may use information such as active cycles of the user 30 to match the user 30 with one or more coaches 55. The coaching system 50 may allow the user 30 to select a coach to assist the user 30 in completing a cycle or achieving a goal. In an aspect, the coaching system 50 may be coupled with the network 40 via an application programming interface (API) 52. The API 52 may allow the user 30 to share information such as questionnaire answers, documents, goals, and obstacles with the selected coach 55 without making such information available to other coaches or users. The API 52 may also restrict the personal information accessible to both the coach 55 and the user 30. For example, the API 52 may not share personal contact information such that the API 52 and coaching system 50 remains the primary contact point between the coach 55 and the user 30. For example, the coaching system 50 may initiate live text chat, screen sharing, and audio or video coaching sessions based on information shared through the API 52. An example interface 1300 for the coaching system 50 is discussed below with respect to FIG. 13. Similarly, the organizational leader system 60 may allow a leader 65 to access information regarding learners within the organization of the leader 65 via the API 52. The API 52 may also provide tools for creating educational cycles, goals, and badges for the learners within the organization of the leader 65. The API 52, however, may prevent the leader 65 from accessing information of users outside of the organization of the leader 65.

A content system 80 may provide information or activities to a user 30 in the form of cycles and resources. A cycle may be a structure for guiding a learner through conducting an educational activity. In an aspect, for example, a cycle may include a plurality of stages including: a pre-activity reflection, an activity template, and a post-activity reflection. The content system 80 may store the cycle and present the cycle to one or more users 30 via the application server 42. A resource may be any information that is associated with a cycle but does not fit within one of the structured stages of a cycle. In an aspect, organizational leaders 65 may generate content (e.g., cycles and resources) using the content system 80. For example, an organizational leader 65 may generate a new cycle and make the cycle available or assigned to users within the organization. In an aspect, the content system 80 may be implemented by one or more of the servers 42.

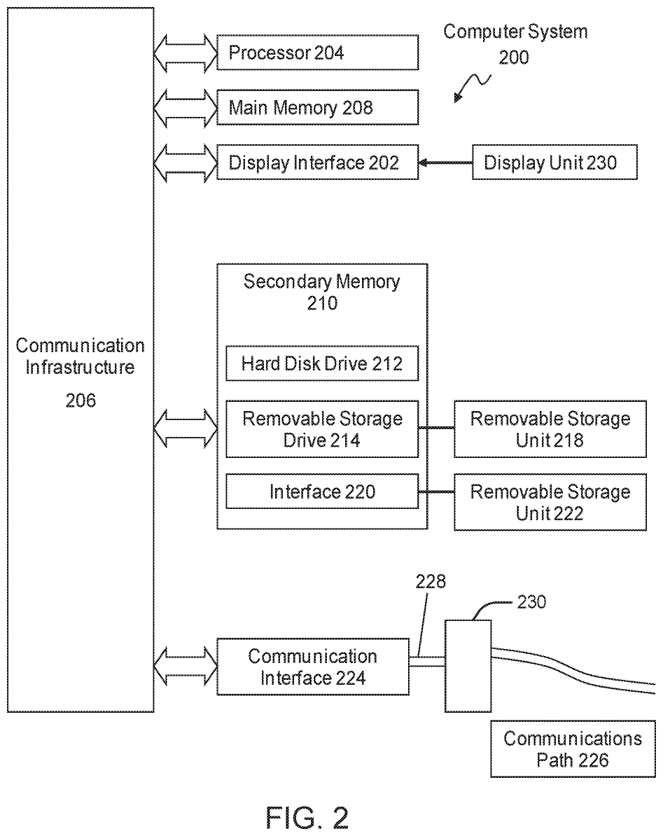

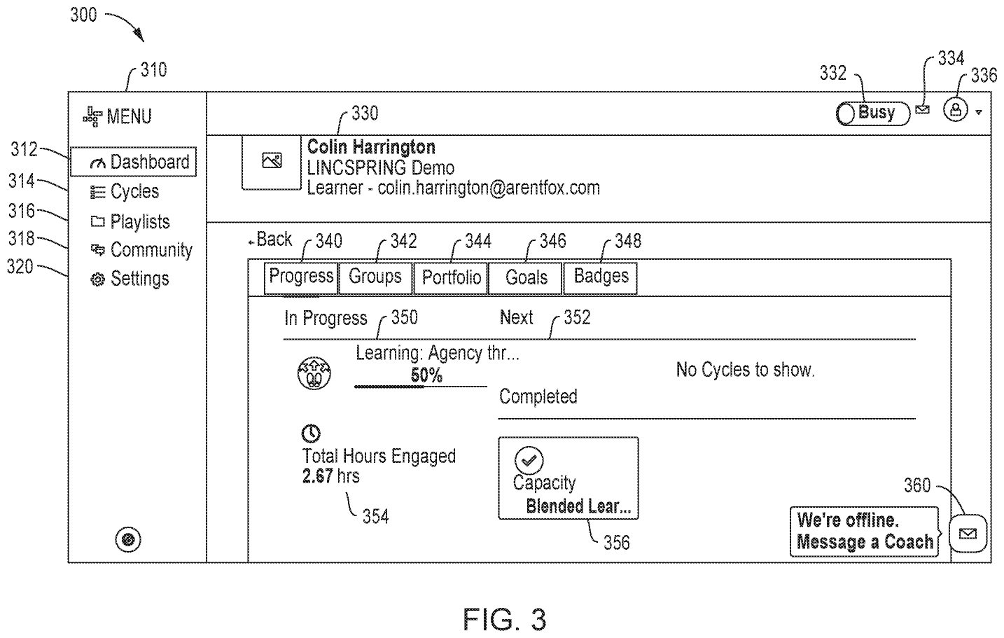

Aspects of the present disclosure may be implemented using hardware, software executed by a processor, or a combination thereof and may be implemented in one or more computer systems or other processing systems. For example, the user interfaces illustrated in FIGS. 3-13 may be implemented as a computer system or processing system. Also, the coaching system 50, organizational leader system 60, and content system 80 (FIG. 1) may be implemented as a computer system or processing system. In an aspect of the present invention, features are directed toward one or more computer systems capable of carrying out the functionality described herein. An example of such a computer system 200 is shown in FIG. 2.

Computer system 200 includes one or more processors, such as processor 204. The processor 204 is coupled to a communication infrastructure 206 (e.g., a communications bus, cross-over bar, or network). Various software aspects are described in terms of this example computer system. After reading this description, it will become apparent to a person skilled in the relevant art(s) how to implement aspects hereof using other computer systems and/or architectures.

Computer system 200 may include a display interface 202 that forwards graphics, text, and other data from the communication infrastructure 206 (or from a frame buffer not shown) for display on a display unit 230. Computer system 200 may include a main memory 208, preferably random access memory (RAM), and may also include a secondary memory 210. The secondary memory 210 may include, for example, a hard disk drive 212 and/or a removable storage drive 214, e.g., an optical disk drive. The removable storage drive 214 may read from and/or write to a removable storage unit 218 in a well-known manner. As will be appreciated, the removable storage unit 218 may include a computer readable storage medium having stored therein computer software and/or data.

Alternative aspects of the present invention may include secondary memory 210 and may include other similar devices for allowing computer programs or other instructions to be loaded into computer system 200. Such devices may include, for example, a removable storage unit 222 and an interface 220. Examples of such may include a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 may allow software and data to be transferred among computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 may be in the form of signals 228, which may be electronic, electromagnetic, optical or other signals capable of being received by communications interface 224. These signals 228 may be provided to communications interface 224 via a communications path (e.g., channel) 226. This path 226 may carry signals 228 and may be implemented using wire or cable, fiber optics, a telephone line, a cellular link, a radio frequency (RF) link and/or other communications channels. The path 226 may include a router 230. As used herein, the terms “computer readable medium,” “computer program medium,” and “computer usable medium” refer generally to media such as a removable storage drive 280, and/or a hard disk installed in hard disk drive 270. These computer program products may provide software to the computer system 200. Aspects of the present invention are directed to such computer program products.

Computer programs (also referred to as computer control logic) may be stored in main memory 208 and/or secondary memory 210. Computer programs may also be received via communications interface 224. Such computer programs, when executed, may enable the computer system 200 to perform the features in accordance with aspects of the present invention, as discussed herein. In particular, the computer programs, when executed, may enable the processor 204 to perform the features in accordance with aspects of the present invention. Accordingly, such computer programs may represent controllers of the computer system 200.

Where aspects of the present invention may be implemented using software, the software may be stored in a computer program product and loaded into computer system 200 using removable storage drive 214, hard disk drive 212, or interface 220. The control logic (software), when executed by the processor 204, may cause the processor 204 to perform the functions described herein. In another aspect of the present disclosure, the system may be implemented primarily in hardware using, for example, hardware components, such as application specific integrated circuits (ASICs). Implementation of the hardware state machine so as to perform the functions described herein will be apparent to persons skilled in the relevant art(s). In yet another variation, aspects of the present disclosure may be implemented using a combination of both hardware and software.

FIG. 3 is a diagram illustrating an example user interface 300 for a user dashboard that provides a user 30 with an overview of the system 100 and navigation tools for accessing various features. The user interface 300 may include a menu 310, a user information section 330, a progress tab 340, a groups tab 342, a portfolio tab 344, a goals tab 346, and a badges tab 348. The progress tab 340 is illustrated as being selected.

The user interface 300 may present the user 30 with an onboarding survey the first time the user 30 accesses the system 100. The onboarding survey may ask the user 30 about culture, technology, learning structure and methodology, and capacity. The system 100 may suggest goals based on the onboarding survey. In an aspect, for example, the system 100 may include a roadmap for an organization that includes areas of development desired by organizational leaders. For example, the organizational leaders may choose to focus development on use of new technology. The system 100 may provide the organizational leaders with results of onboarding surveys as well as questionnaires completed by learners such that the organizational roadmap is a collective process for the organization. The system 100 may align the organizational roadmap with suggested cycles and playlists. For a specific user 30, the system 100 may compare the onboarding survey to the organizational roadmap to set a goal and assign an initial playlist for meeting the goal.

The menu 310 may provide links or buttons that open different user interfaces. For example, the menu 310 may include a dashboard button 312, a cycles button 314, a playlist button 316, a community button 318, and a settings button 320. Each of the buttons may navigate to a corresponding user interface, as discussed in further detail below. The menu 310 may be included on each user interface presented by the system 100.

The user information section 330 may display information about the user and include tools related to a user account and user role. For example, the user information section 330 may display a user name, user picture, user organization, user role, and user email address. The user name and user picture may be selected by the user 30. The user organization may be a primary organization of the user that has registered with the system 100. The user role may be one of: learner, coach, organizational leader, or administrator, for example. For users with more than one role, the user select button 336 may allow the user to change an active role. The user email address may be provided by the user 30. In an aspect, the user email address may be associated with an organization. The organization may be selected based on the email address during user registration.

The user information section 330 may also include user tools including a user status indicator 332, a messaging tool 334, and a user select button 336. The user status indicator 332 may allow the user 30 to select a status to display to other users such as, available, busy, or away. The system 100 may automatically determine the status to display based on user behavior. For example, the system 100 may change the status to busy if the user 30 starts a communication with a coach. The messaging tool 334 may provide an interface for the user 30 to send a message to another user within the system 100. The message may be an email, a chat message, or both. For example, the system 100 may send an email if the other use is busy or away, but send a chat message if the user is available. The user select button 336 may allow the user 30 to log out, or to change to a different user or different role. For example, selecting the user select button 336 may present a list of roles associated with an account of the user 30 and an option to sign into a different account.

The progress tab 340 may display information regarding the progress of the user 30 towards one or more of cycles or goals. For example, the progress tab 340 may include a cycle progress indicator 350 that indicates progress within a current cycle, which may be a most recent cycle accessed by the user 30. For example, the progress may be presented as a percentage of tasks completed. The progress tab 340 may include a next cycle indicator 352 that indicates a cycle to be accessed after the current cycle. The progress tab 340 may include an engagement monitor 354 that display a total amount of time that the user 30 has been active on the system 100. The engagement monitor 354 may display the engagement time for a time period such as a month, semester, or school year. The progress tab 340 may include a completed cycle indicator 356 that displays one or more cycles that have been completed, for example, within a time period (e.g., one week).

The user interface 300 may also include a coaching button 360 that accesses an interface for communicating with a coach. As explained in further detail below, a coach is a distinct user role that is associated with an accreditation for an organization, cycle, or group of cycles. The coaching button 360 may display a list of available coaches that are associated with the organization of the user 30 and/or accredited for the current cycle indicated by the cycle progress indicator 350. A user 30 may select the coaching button 360 to send a message to one or more coaches that are currently available.

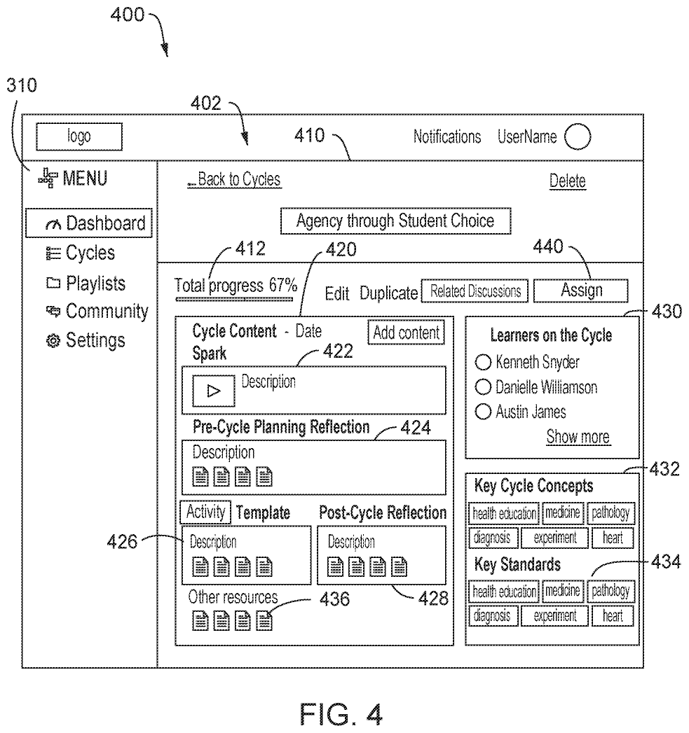

FIG. 4 is a diagram illustrating an example user interface 400 for an educational cycle 402. The user interface 400 may include the menu 310 described above. The user interface 400 may include a cycle name field 410 that displays a unique name for a selected learning cycle 402. For example, the selected learning cycle 402 may be titled “Agency through Student Choice” and may correspond to the current cycle indicated by the cycle progress indicator 350. The user interface 400 may include a progress indicator 412 that indicates a level of progress on the selected learning cycle 402. The user interface 400 may include a cycle content area 420 that presents the current content of a cycle, which may be edited by a user (e.g., an organizational leader or coach) responsible for the cycle. The cycle content area 420 may include at least an informational presentation 422, a pre-activity reflection 424, an activity template 426, a post-activity reflection 428, and other resources 436. The user interface 400 may include an indicator or alter the appearance of an item within the cycle content area 420 when the item is completed. The user interface 400 may update the progress indicator 412 when the item is completed.

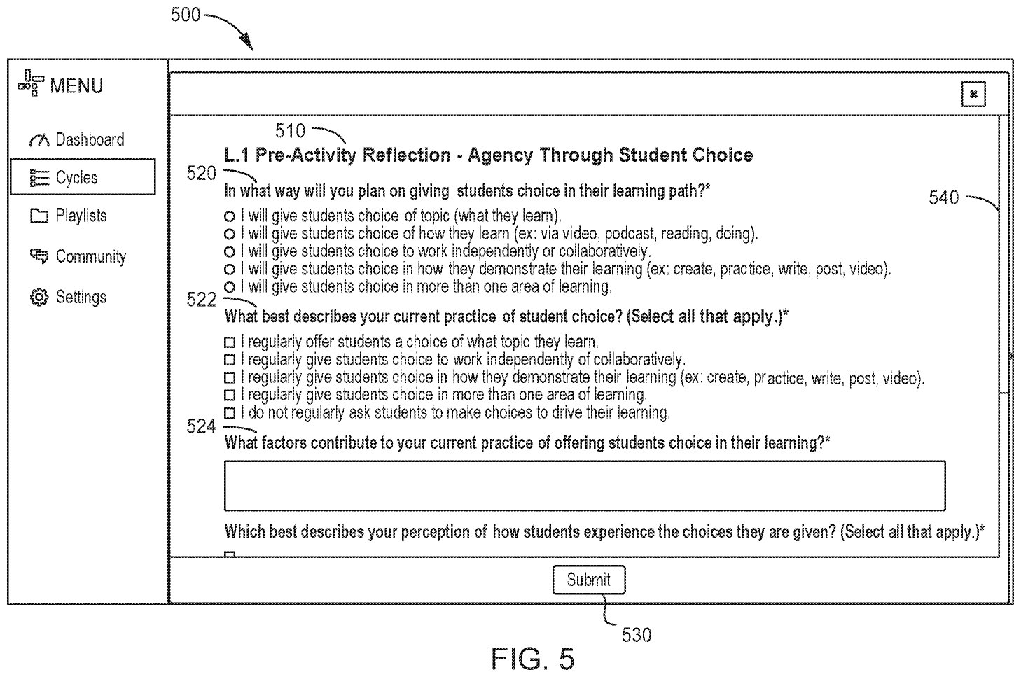

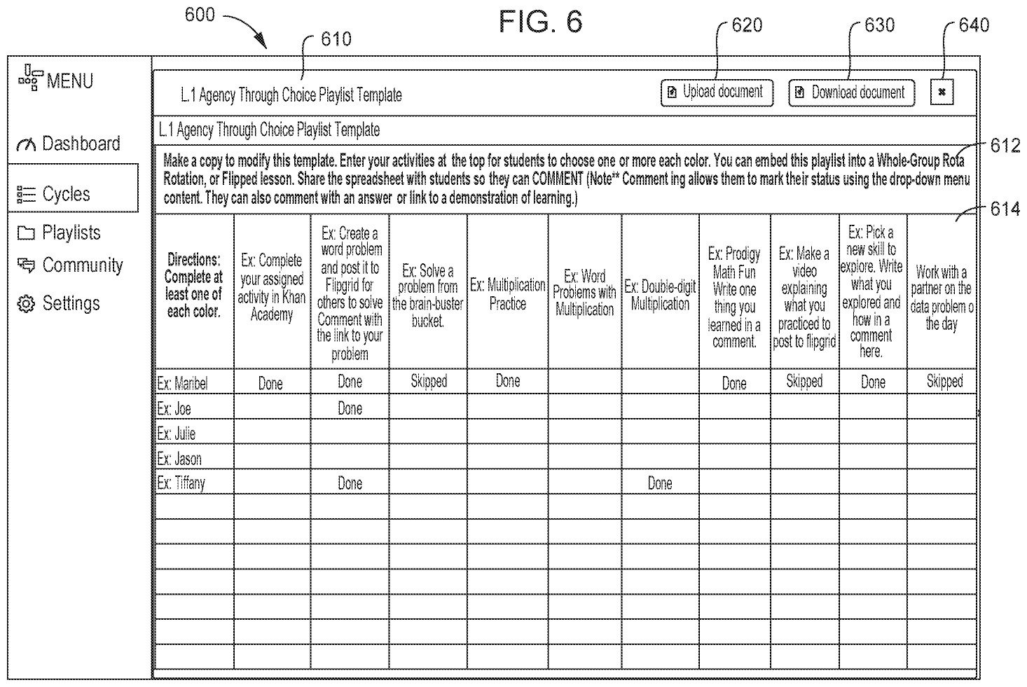

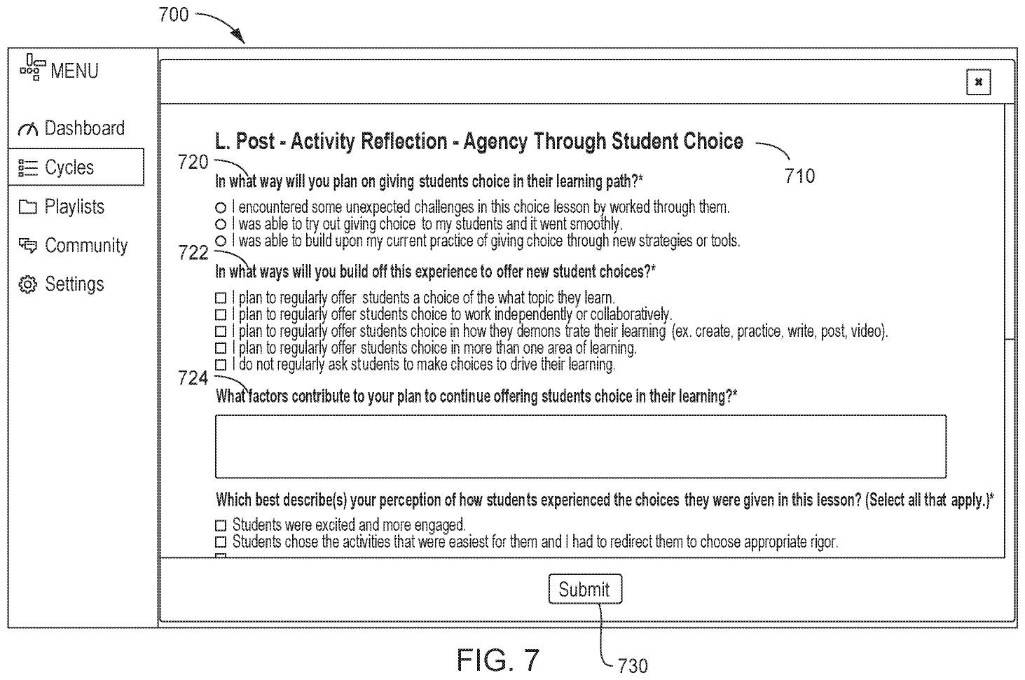

The informational presentation 422 may be referred to as a spark and may include any presentation of information related to the cycle that provides information about the cycle and/or encourages the user 30 to think about the cycle topic. The informational presentation 422 may be a hyperlink that opens a user interface for displaying the presentation. For example, the informational presentation 422 may open a video player or web-browser. Other examples of presentations may include slide shows, images (e.g., infographics), academic papers, or documents. The pre-activity planning reflection 424 may provide a set of questions about the user, the cycle topic, and the level of experience of the user with respect to the cycle topic. An example interface 500 for presenting the pre-activity planning reflection 424 is illustrated in FIG. 5 and discussed in further detail below. The activity template 426 may provide a planning document for an activity related to the cycle. For example, the activity template 426 may provide a lesson plan, handout, chart, graphs, etc. The activity template 426 may include an example document and instructions on how to edit the document. An example interface 600 for presenting the activity template 426 is illustrated in FIG. 6 and discussed in further detail below. The post-activity reflection 428 may provide a set of questions about the user, the cycle topic, and the activity completed based on the activity template 426. An example interface 700 for presenting the post-activity reflection 428 is illustrated in FIG. 7 and discussed in further detail below. The other resources 436 may include hyperlinks to other resources related to the cycle. For example, the other resources may include videos, presentations, example lesson plans, handouts, etc. The resources may be stored within the system 100 (e.g., in content system 80 or storage server 43) or may be external resources.

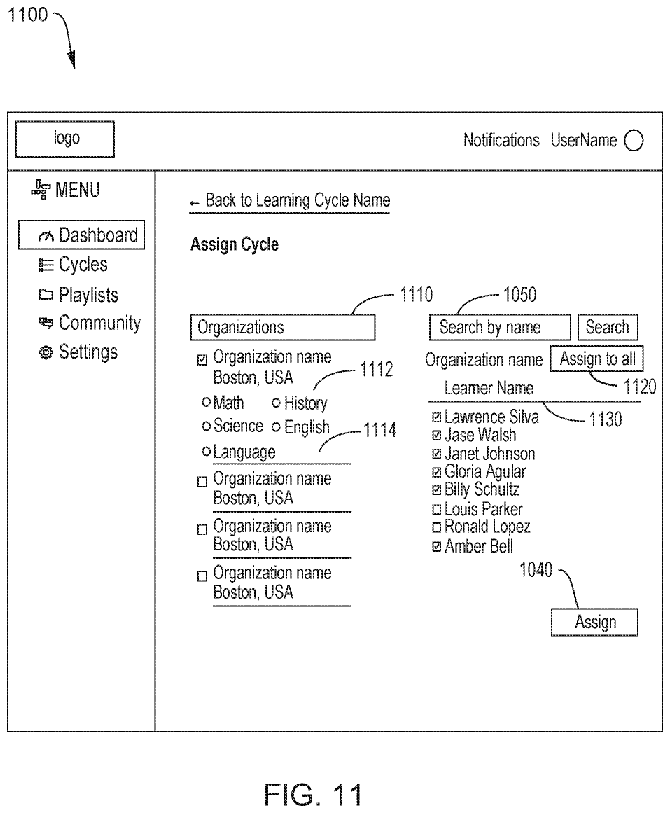

The user interface 400 may include a learner communication list 430 that presents the names of other users (e.g., learners) that are active in the current cycle. Each name may be associated with a status indicator for the user. The user 30 may interact with the user name to select a communication option for contacting another user. The learner communication list 430 may be selected or filtered based on organization such that the user 30 only sees other users associated with the organization. The user interface 400 may include an assign button 440 that is only visible or usable by users with a role of organizational leader or administrator. The assign button 440 may open the user interface 1100 as discussed in detail below with respect to FIG. 11.

The user interface 400 may include a list of key cycle concepts 432. Each item in the list of key cycle concepts 432 may be a link that displays a definition of the concept in a pop-up window. Similarly, the user interface 400 may include a list of key standards 434. Each item in the list of key standards 434 may be a link that displays an explanation of the relationship between the current cycle and a standard in a pop-up window. For example, the explanation may include a relevant section of the standard.

FIG. 5 is a diagram illustrating an example user interface 500 for a pre-activity reflection. The pre-activity reflection may ask a learner to think about the activity with respect to the present practices and past experience of the learner. The pre-activity reflection may include questions to encourage goal setting and strategizing. The user interface 500 may include a title 510 for the reflection and the cycle. The user interface 500 may include a set of questions related to the cycle and the experience of the user 30. The questions may be multiple-choice questions, checklists, or free-form questions. For example, a first question 520 may include multiple choices, each associated with a radio button for selecting the desired choice. The second question 522 may include multiple choices, each associated with a checkbox to allow selection of one or more choices. The third question 524 may include a text field for entering text for the free-form third question 524. The user interface 500 may include a scroll bar 540 that brings additional questions into view. The user interface 500 may include a submit button 530 to complete the pre-activity reflection. The system 100 may check that each question is answered when the submit button 530 is selected. The system 100 may store the completed pre-activity reflection in association with the user 30. The system 100 may provide other users (e.g., coaches or organizational leaders) with access to the stored pre-activity reflection.

FIG. 6 is a diagram illustrating an example user interface 600 for an activity plan template. The user interface 600 may include a title 610 of the current cycle and template. The user interface 600 may include instructions 612 and a document preview 614. The document preview 614 may display a preview of a downloadable template document. In an aspect, the document preview may be editable. The user interface 600 may include a download document button 630. The user 30 may select the download document button 630 to make a local copy of the template shown in the document preview 614. The local copy may be any form of electronic document known in the art. The template may vary depending on the cycle. Generally, the template includes at least one portion to be edited based on specifics of a planned activity. For example, the user 30 may edit a participant list or content for a particular educational activity. The user 30, however, may not need to create additional documents or sections, or make any changes to formatting of the electronic document. Accordingly, providing the template may facilitate practice in a new activity. The user interface 600 may include an upload document button 620. The user 30 may select the upload document button 620 to open an interface for uploading the completed local copy of the template. For example, the user interface 600 may include an area to drag and drop a completed document file icon and/or allow the user 30 to browse a local storage system for the completed document file. The user interface 600 may include a close button 640 to close the user interface 600 without completing the template document.

FIG. 7 is a diagram illustrating an example user interface for a post-activity reflection. The post-activity reflection may ask the learner to think about the successes and failures of the activity. For example, the post-activity reflection may ask how the activity was conducted and whether the activity proceeded as planned. The post-activity reflection may solicit feedback on the activity and suggestions for changes. The user interface 700 may include a title 710 for the reflection and the cycle. The user interface 700 may include a set of questions related to the cycle and the experience of the user 30 in performing the activity based on the template. The questions may be multiple-choice questions, checklists, or free-form questions. For example, a first question 720 may include multiple choices, each associated with a radio button for selecting the desired choice. The second question 722 may include multiple choices, each associated with a checkbox to allow selection of one or more choices. The third question 724 may include a text field for entering text. The user interface 700 may include a submit button 730 to complete the post-activity reflection. The system 100 may check that each question is answered when the submit button 730 is selected. The system 100 may store the completed post-activity reflection in association with the user 30. The system 100 may provide other users (e.g., coaches or organization leaders) with access to the stored post-activity reflection.

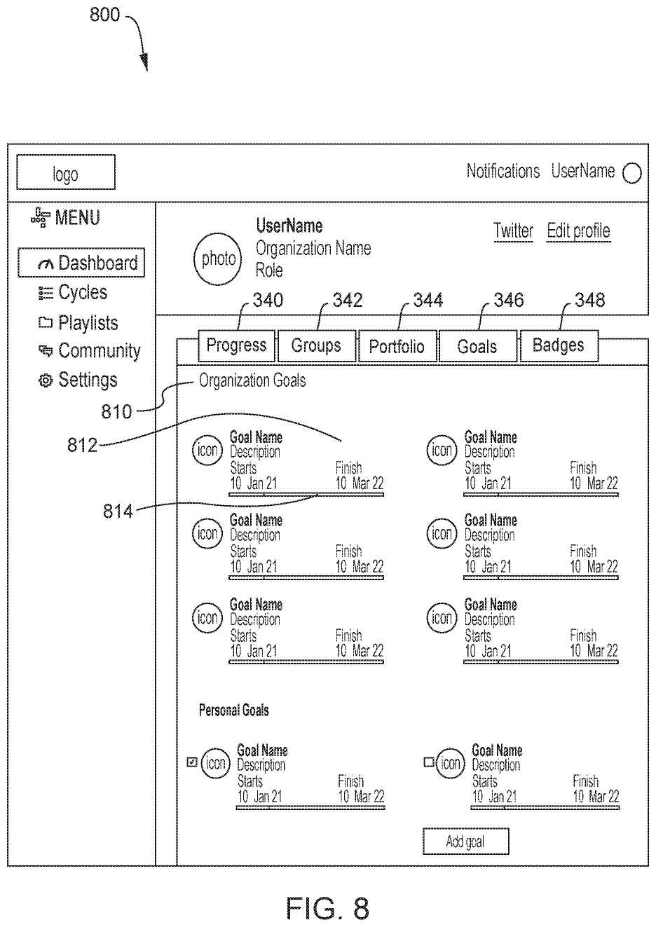

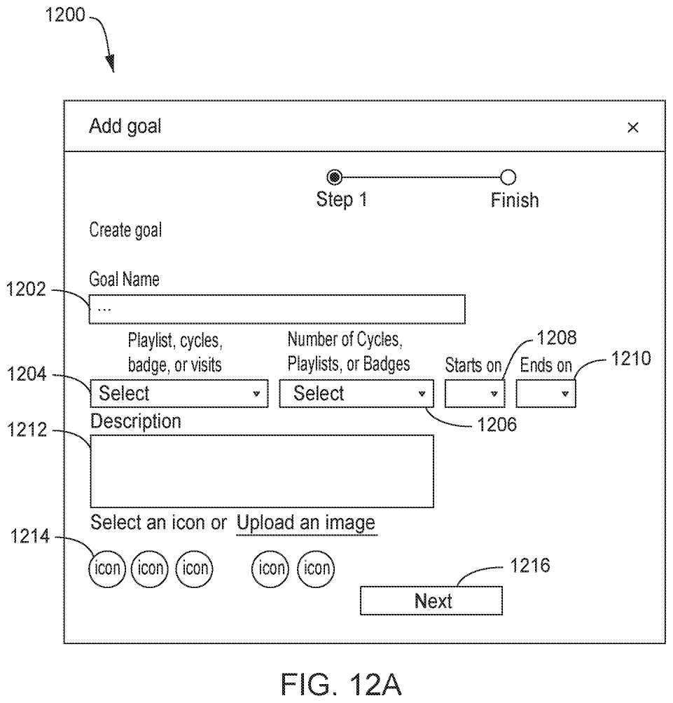

FIG. 8 illustrates an example user interface 800 for showing goals on a dashboard. The user interface 800 may be accessed by selecting the goals tab 346 on the dashboard. The user interface 800 may include organizational goals 810 and personal goals 820. The organizational goals 810 may be selected by an organizational leader and assigned to one or more learners or groups of learners. Each goal 812 may include a goal name, description of the goal, and icon representing the goal. Each goal 812 may also include a progress indicator 814 that may show a current level of progress. The progress indicator may show a start date and a target completion date. In an aspect, progress toward a goal may be achieved by completing cycles. The cycles may be arranged in a playlist. The personal goals 820 may be selected by the user 30 and may include the goal name for a goal 812, description of the goal, and icon representing the goal as well as the progress indicator 814. The user interface 800 may include an add goal button 830 that opens the user interface 1200 shown in FIG. 12A when selected.

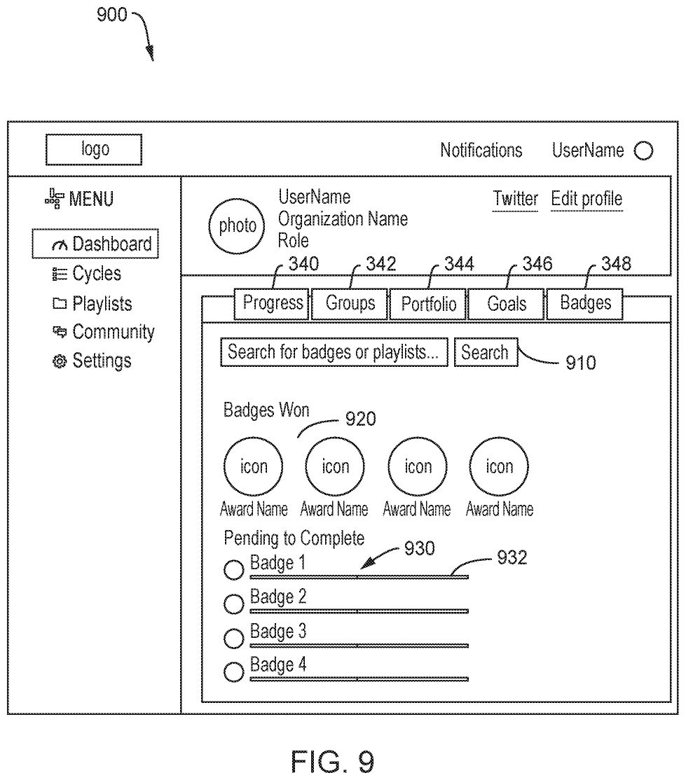

FIG. 9 illustrates an example user interface 900 for showing completed badges on a dashboard. The user interface 900 may be accessed by selecting the badges tab 348 on the dashboard. A badge may be an indication that a goal has been completed. For example, a badge may be compliant with the open badges standard. The badges may be used by a user 30 or organization (e.g., leader 65) to track progress. In an aspect, a badge may be associated with a specific requirement or credential. For example, an organization may require a learner to obtain a badge before being eligible for specific events, activities, or positions. The user interface 900 may include a search tool 910 for finding badges, goals, or playlists. The user interface 900 may include a badges display area 920 that shows an icon representing each badge earned. The user interface 900 may include a pending badges area 930 that shows a progress indicator 932 for each badge in progress. The progress indicator 932 may be based on or show the same level or progress as the corresponding progress indicator 814 on the goals user interface 800.

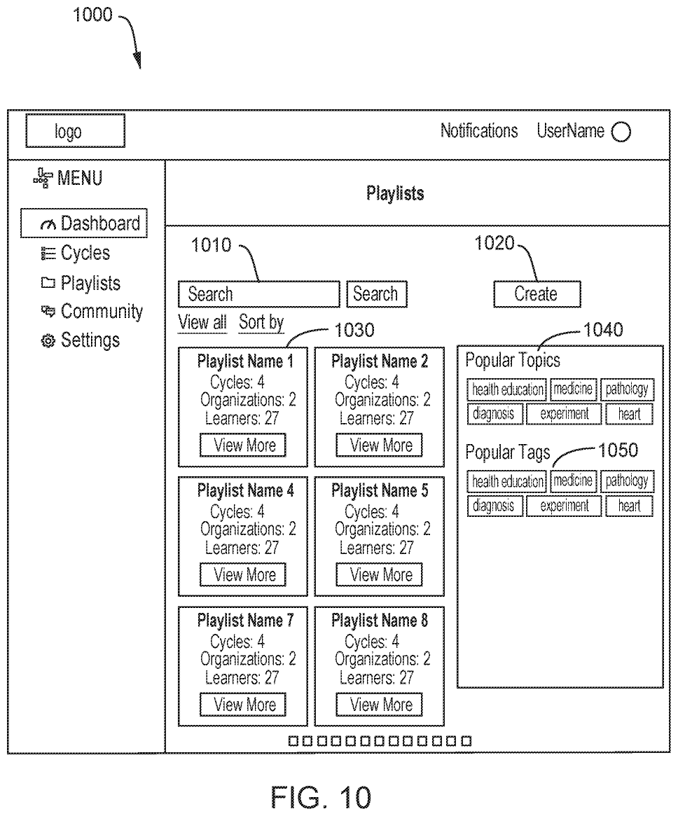

FIG. 10 is a diagram illustrating an example user interface 1000 including one or more playlists 1030 of multiple educational cycles. The user interface 1000 may include a search tool 1010 to find a specific playlist 1030 based on topic, tag, keyword, or description. The user interface 1000 may include a popular topics list 1040 that includes topics that have been recently searched. The user interface 1000 may include a popular tags list 1050 that includes tags associated with playlists that have been accessed frequently. Accordingly, a user 30 may search for playlists by selecting an item from the popular topics list 1040 or the popular tags list 1050. The user interface 1000 may include a create button 1020. When the user 30 selects the create button 1020, the user interface 1000 may provide fields for entering a name, description, and tags for a new playlist. The user interface 1000 may include one or more playlists 1030 that have been selected by the user 30 or assigned to the user 30. Each playlist 1030 may display a number of cycles included in the playlist, number of organizations that have assigned the playlist, and a number of learners active on the playlist. A user may select a playlist 1030 to see the individual cycles within the playlist.

FIG. 11 is a diagram illustrating an example user interface 1100 for associating an education cycle with a user or organization. The user interface 1100 may be accessible by a user in the role of an organizational leader or administrator. For example, the user interface 1100 may be accessed via an assign button 440 on the user interface 400 shown in FIG. 4. The user interface 1100 may include a list of organizations 1110. The list of organizations 1110 may include each organization that the organizational leader or administrator is associated with. Each organization 1112 may be identified by a name and a location. In an aspect, an organization 1112 may include groups 1114. For example, the groups may be based on grade level or subject matter. The organization 1112 and groups 1114 may be selectable and a checkbox or radio button may indicate whether the organization or group is selected. The user interface 1100 may include a list of learners 1130 that displays the names of all users with the learner role that are associated with the selected organization and/or group. Accordingly, selecting the organization 1112 or group 1114 may add users to the list of learners 1130. Each learner in the list of learners 1130 may be individually selectable via a checkbox, for example. The user interface 1100 may include an assign to all button 1120 that may select each learner in the list of learners 1130 when selected. The user interface 1100 may also include an assign button 1140 that assigns the selected cycle to each of the selected learners.

FIGS. 12A and 12B illustrate an example interface 1200 for configuring a user achievable goal. The user interface 1200 may be accessed by a user in the role of learner to configure a personal goal, or a user in the role of organizational leader to configure a goal for learners within the organization. The user interface 1200 may include a first page that includes a goal name field 1202, a content selector 1204, an amount selector 1206, a start date selector 1208, and an end date selector 1210, description field 1212, and a selectable set of badges 1214. The user 30 may enter text and select the appropriate content and dates using the user interface 1200. The user interface 1200 may include a next button 1216 that displays the second page 1220.

The second page 1220 may be used to select content to be completed to achieve the goal. The second page 1220 may include a search tool 1230 that may include a text field for searching for relevant playlists or cycles. The second page 1220 may include a list of playlists 1240 including one or more playlists 1242. Each playlist 1242 may include one or more cycles 1244. Each playlist 1242 and cycle 1244 may be associated with a checkbox. Accordingly, the user 30 may select which playlists and/or cycles are included in the goal. The second page 1220 may include an add button 1250 to add the goal for the user or the organization based on the user role. In an aspect, the user interface 1200 may be presented as a single page including the content of the user interface 1200 and the second page 1220.

FIG. 13 illustrates an example user interface 1300 for a coach 55 to monitor users 30. The user interface 1300 may also be accessed by organizational leaders 65 and/or administrators. The user interface 1300 may include a user list 1310 including entries for users visible to the coach 55, organizational leader 65, or administrator. The visible users may be determined based on the role and/or credentials of the coach 55, organizational leader 65, or administrator. For example, the user interface for a coach 55 may include any user 30 with an active cycle for which the coach has a credential. As another example, the user interface 1300 for an organization leader 65 may include users within an organization of the organizational leader. For each user, the user interface 1300 may display a number of hours 1312, a number of cycles completed 1314, a date of last login 1316, a date of last contribution 1318, and action buttons 1320. The action buttons 1320 may initiate a chat with the user 30 via a live message service or email. The coach 55 or organizational leader 65 may filter the users 30 that are displayed based on a group 1330 and/or cycle 1332. For example, a coach 55 may want to check progress on a specific cycle to see which users may need assistance. An organizational leader may want to check the progress of various groups within the organization.

The user interface 1300 may also provide an organization summary 1340 providing information about an organization. For example, the organization summary may include a total number of hours 1342 for the organization, a total number of cycles completed 1344 for the organization, and action buttons 1346 that initiate a message or email to all users within the organization.

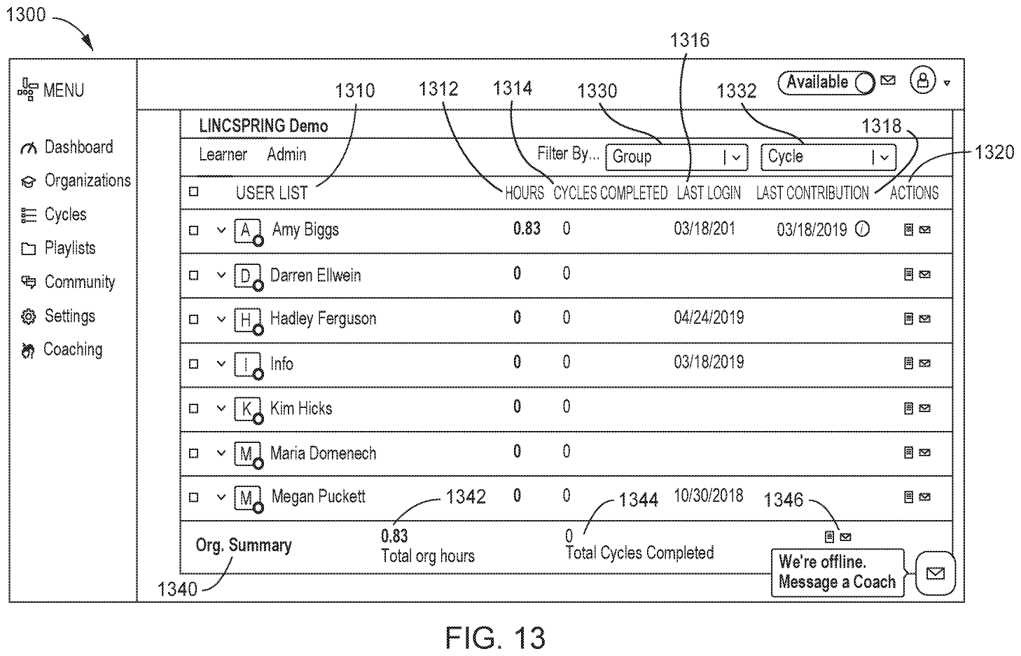

Referring to FIG. 14 receiver component 140, in an operational aspect, a computer system 200 (FIG. 2) such as the user device 20 (FIG. 1) or a server 42 (FIG. 1) may perform one aspect of a method 14 receiver component 14000 for providing professional development. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein. Optional blocks are shown in dashed lines.

In block 1401, the method 1400 may optionally include selecting a personalized playlist from a plurality of educational cycles based on an onboarding survey of the user. In an aspect, for example, the server 42 may selecting the personalized playlist from the plurality of educational cycles based on an onboarding survey of the user 30. For example, the server 42 may determine a position of the user 30 with respect to an organizational roadmap for an organization of the user. The server 42 may select cycles for the personalized playlist that will advance the user with respect to the organizational roadmap.

In block 1402, the method 1400 may include presenting a dashboard to a user, the dashboard including at least one educational cycle for the user, wherein the educational cycle includes at least a video, a pre-activity questionnaire, an activity plan template, and a post-activity questionnaire. In an aspect, for example, the server 42 may present a dashboard (e.g., user interface 300) to a user 30 via a user device 20, the dashboard including at least one educational cycle 402 for the user, wherein the educational cycle 402 includes at least a video (e.g., informational presentation 422), a pre-activity questionnaire (e.g., pre-activity reflection 424), an activity template 426, and a post-activity questionnaire (e.g., post-activity reflection 428).

In block 1404, the method 1400 may include receiving a completed pre-activity questionnaire. In an aspect, for example, the server 42 may receive a completed pre-activity questionnaire from the user 30 via the user interface 500. For instance, the server 42 may present the user interface 500 to the user 30. The user 30 may complete the pre-activity questionnaire by selecting responses and entering text into the user interface 500. When the user 30 selects the submit button 530, the user interface 500 may generate document or database entry including the content of the pre-activity questionnaire. The server 42 may store the completed pre-activity questionnaire in association with the user 30 and the current cycle. In an aspect, the server 42 may check that each question of the pre-activity questionnaire is completed. Accordingly, the receipt of the completed pre-activity questionnaire may indicate that the user 30 has completed a stage of the cycle.

In block 1406, the method 1400 may include receiving a completed activity plan template. In an aspect, for example, the server 42 may receive the completed activity plan template from a user 30 via the user interface 600. For example, as described above with respect to FIG. 6, the user 30 may download the template document, complete the document, and upload the completed document. The server 42 may store the completed template document in association with the user 30 and the current cycle. Accordingly, the receipt of the completed template document may indicate that the user 30 has completed a stage of the cycle.

In block 1408, the method 1400 may include receiving a completed post-activity questionnaire. In an aspect, for example, the server 42 may receive a completed post-activity questionnaire from the user 30 via the user interface 700. For instance, the server 42 may present the user interface 700 to the user 30. The user may complete the post-activity questionnaire by selecting responses and entering text into the user interface 700. When the user 30 selects the submit button 730, the user interface 700 may generate document or database entry including the content of the post-activity questionnaire. The server 42 may store the completed post-activity questionnaire in association with the user 30 and the current cycle. In an aspect, the server 42 may check that each question of the post-activity questionnaire is completed. Accordingly, the receipt of the completed post-activity questionnaire may indicate that the user 30 has completed a stage of the cycle.

In block 1410, the method 1400 may include determining that the cycle is completed in response to receiving the completed pre-activity questionnaire, the completed activity plan template, and the completed post-activity questionnaire. In an aspect, for example, the server 42 may determine that the cycle is completed in response to receiving the completed pre-activity questionnaire, the completed activity plan template, and the completed post-activity questionnaire.

In block 1412, the method 1400 may optionally include aggregating post-activity questionnaires from a plurality of users who have completed the cycle. In an aspect, for example, the server 42 may aggregate post-activity questionnaires from a plurality of users who have completed the cycle. For example, each of the post-activity questionnaires may be received via the user interface 700. The server 42 may aggregate the responses for individual questions of the questionnaire for an organization or group. For example, the server 42 may generate a cumulative or average score for a question with a numerical answer or scale, or the server 42 may determine a percentage of users selecting each option for a multiple choice question.

In block 1414, the method 1400 may optionally include providing the aggregated information to a user in a role of an organizational leader. In an aspect, for example, the server 42 may provide the aggregated information to a user (e.g., leader 65) in a role of an organizational leader.

In block 1416, the method 1400 may optionally include determining that the user has completed a professional education requirement in response to determining that the cycle is completed. In an aspect, for example, the server 42 may determine that the user 30 has completed a professional education requirement in response to determining that the cycle is completed. In an aspect, a microcredential such as an open badge may be awarded for completing a cycle or a playlist. For example, the documents for the completed cycle and/or playlist (e.g., the pre-activity questionnaire, activity template, and post-activity questionnaire) may be provided to a reviewer, who may be an organizational leader 65 or coach 55, to certify completion and award the microcredential.

In block 1418, the method 1400 may optionally include adding an entry to a blockchain ledger indicating the user has completed a playlist in response to determining that the cycle is completed and the playlist fulfills a credential requirement. In an aspect, for example, the server 42 may add an entry to the blockchain ledger 46 indicating the user has completed the playlist in response to determining that the cycle is completed and the playlist fulfills a credential requirement. Similar to block 1416, the documents for the completed cycle and/or playlist (e.g., the pre-activity questionnaire, activity template, and post-activity questionnaire) may be provided to a reviewer, who may be an organizational leader 65 or coach 55, to certify completion of the credential requirement and award the blockchain certification.

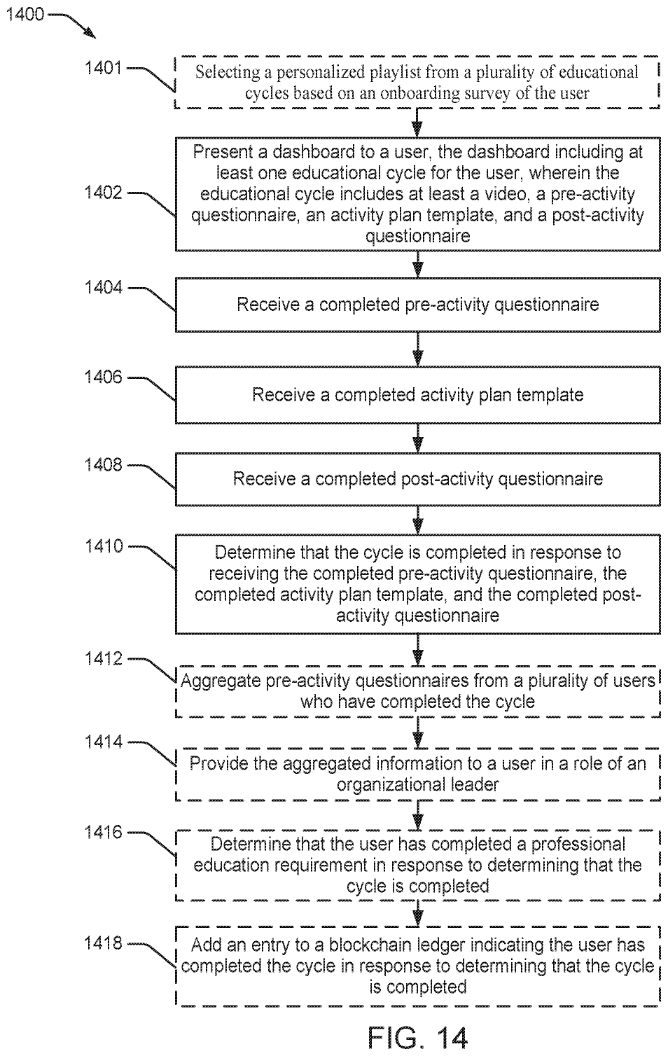

Referring to FIG. 15, in an operational aspect, a computer system 200 (FIG. 2) such as the user device 20 (FIG. 1) or a server 42 (FIG. 1) may perform one aspect of a method 1500 for assigning playlists. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein. Optional blocks are shown in dashed lines.

In block 1502, the method 1500 may include providing a user interface to an organizational leader, the user interface includes a plurality of playlists and a plurality of groups of users. In an aspect, for example, the server 42 may provide the user interface 1100 to an organizational leader 65, the user interface 1100 including a plurality of cycles and a plurality of groups of users.

In block 1504, the method 1500 may include receiving a selection of at least one cycle and at least one group of users from the organizational leader. In an aspect, for example, the server 42 may receive a selection of at least one playlist and at least one group of users from the organizational leader 65.

In block 1506, the method 1500 may include assigning the at least one playlist to each member user of the at least one group of users, wherein presenting the dashboard to the user includes presenting the at least one assigned playlist. In an aspect, for example, the server 42 may assign the at least one cycle to each member user of the at least one group of users, wherein presenting the dashboard (e.g., user interface 300) to the user includes presenting the at least one assigned playlist 1030.

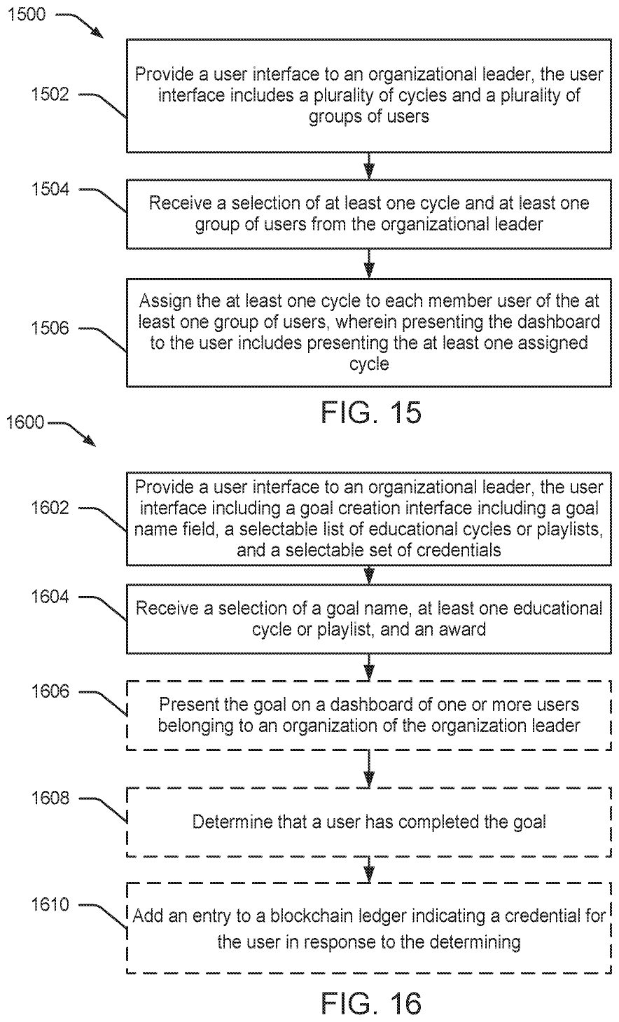

Referring to FIG. 16, in an operational aspect, a computer system 200 (FIG. 2) such as the user device 20 (FIG. 1) or a server 42 (FIG. 1) may perform one aspect of a method 1600 for assigning goals. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein. Optional blocks are shown in dashed lines.

In block 1602, the method 1600 may include providing a user interface to an organizational leader, the user interface including a goal creation interface including a goal name field, a selectable list of educational cycles or playlists, and a selectable set of credentials. In an aspect, for example, the server 42 may provide the user interface 1200 to the organizational leader 65, the user interface 1200 including a goal creation interface including a goal name field 1202, a selectable list of educational cycles or playlists 1240, and a selectable set of badges 1214.

In block 1604, the method 1600 may include receiving a selection of a goal name, at least one educational cycle or playlist, and an award. In an aspect, for example, the server 42 may receive a selection of a goal name, at least one educational cycle or playlist, and an award via the user interface 1200.

In block 1606, the method 1600 may include presenting the goal on a dashboard of one or more users belonging to an organization of the organization leader. In an aspect, for example, the server 42 may present the goal on the user interface 300 of one or more users 30 belonging to an organization of the organization leader 65.

In block 1608, the method 1600 may include determining that a user has completed the goal. In an aspect, for example, the server 42 may determine that the user 30 has completed the goal. For instance, the server 42 may determine that the user 30 has completed each cycle included within the goal.

In block 1610, the method 1600 may include adding an entry to a blockchain ledger indicating a credential for the user in response to the determining. In an aspect, for example, the server 42 may add an entry to the blockchain ledger 46 indicating the credential for the user in response to the determining. The blockchain ledger 46 may be accessed to provide or verify a credential for the user 30.

As used in this application, the terms “component,” “module,” “system” and the like are intended to include a computer-related entity, such as but not limited to hardware, firmware, a combination of hardware and software, software stored as executable instructions on a non-transitory computer readable medium, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. While the foregoing disclosure discusses illustrative aspects and/or embodiments, it should be noted that various changes and modifications could be made herein without departing from the scope of the described aspects and/or embodiments as defined by the appended claims. Additionally, all or a portion of any aspect and/or embodiment may be utilized with all or a portion of any other aspect and/or embodiment, unless stated otherwise.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. A method for providing education, comprising:
presenting a dashboard to a user, the dashboard including an educational cycle for the user, wherein the educational cycle includes at least a video, a pre-activity questionnaire, an activity plan template, and a post-activity questionnaire;
playing the video to the user;
receiving a completed pre-activity questionnaire;
receiving a completed activity plan template;
receiving a completed post-activity questionnaire; and
determining that the educational cycle is completed in response to receiving the completed pre-activity questionnaire, the completed activity plan template, and the completed post-activity questionnaire.

2. The method of claim 1, wherein the dashboard includes a list of coaches associated with the educational cycle and an indication of availability of each coach, the method further comprising:
receiving a selection of one of the coaches from the user; and
initiating a communication between the user and the coach based on the availability of the coach.

3. The method of claim 2, further comprising providing a coaching dashboard to the coaches, wherein the coaching dashboard presents a list of organizations and users, progress of users on cycles, and a tool to message users.

4. The method of claim 1, wherein the activity plan template is an electronic document that is downloadable or saved in a virtual drive.

5. The method of claim 1, further comprising determining that the user has completed a professional education requirement in response to determining that the cycle is completed.

6. The method of claim 1, wherein the dashboard presents a playlist including a plurality of educational cycles.

7. The method of claim 1, further comprising:
providing a user interface to an organizational leader, the user interface including a plurality of cycles and a plurality of groups of users;
receiving a selection of at least one cycle and at least one group of users from the organizational leader; and
assigning the at least one cycle to each member user of the at least one group of users, wherein presenting the dashboard to the user includes presenting the at least one assigned cycle.

8. The method of claim 1, wherein the dashboard includes a list of other users associated with the educational cycle, wherein selection of one of the other users provides contact information for the other user.

9. The method of claim 1, further comprising providing a user interface to an organizational leader, the user interface including a goal creation interface including a goal name field, a selectable list of educational cycles or playlists, and a selectable set of credentials;
receiving a selection of a goal name, at least one educational cycle or playlist, and a credential for a new goal; and
presenting the new goal on a dashboard of one or more users belonging to an organization of the organizational leader.

10. The method of claim 9, further comprising:
determining that a user has completed the new goal; and
adding an entry to a blockchain ledger indicating the credential for the user in response to the determining.

11. The method of claim 1, further comprising awarding an open badge indicating the user has completed the cycle in response to determining that the cycle is completed.

12. The method of claim 1, further comprising:
aggregating post-activity questionnaires from a plurality of users who have completed the cycle; and
providing the aggregated post-activity questionnaires to an organizational leader.

13. The method of claim 1, wherein the educational cycle is selected from a plurality of educational cycles based on an onboarding survey of the user, wherein each of the educational cycles is assigned a stage of development along a roadmap, and completion of an educational cycle allows access to an associated educational cycle in a next stage of development along the roadmap.

14. A computer system for providing education, comprising:
a server communicatively coupled to a user device via a network;
a first graphical user interface (GUI), generated by the server and transmitted to the user device for display to a user, the first GUI including a dashboard, the dashboard including an educational cycle for the user, wherein the educational cycle includes at least a video, a pre-activity questionnaire, an activity plan template, and a post-activity questionnaire, wherein the server is configured to:
play the video to the user;
receive a completed pre-activity questionnaire;
receive a completed activity plan template;
receive a completed post-activity questionnaire; and
determine that the educational cycle is completed in response to receiving the completed pre-activity questionnaire, the completed activity plan template, and the completed post-activity questionnaire.

15. The computer system of claim 14, further comprising a blockchain ledger, wherein the server is configured to:
determine that the user has completed a professional education requirement in response to determining that a playlist is completed; and
add an entry to the blockchain ledger indicating that the user has completed the professional education requirement.

16. The computer system of claim 15, wherein the server is configured to
determine that a user has completed a goal; and
add an entry to the blockchain ledger indicating a credential for the user based on the completion of the goal.

17. The computer system of claim 14, further comprising a second GUI for an organizational leader, the second GUI including a goal creation interface including a goal name field, a selectable list of educational cycles or playlists, and a selectable set of credentials, wherein the server is configured to:
receive, via the second GUI, a selection of a goal name, at least one educational cycle or playlist, and a credential for a new goal; and
present the new goal on the dashboard of one or more users belonging to an organization of the organizational leader.

18. The computer system of claim 14, wherein the activity plan template is an electronic document that is downloadable or saved in a virtual drive.

19. The computer system of claim 14, further comprising a third GUI for an organizational leader, the third GUI including a plurality of educational cycles and a plurality of groups of users, wherein the server is configured to:
receive a selection of at least one educational cycle and at least one group of users from the organizational leader; and
assign the at least one educational cycle to each member user of the at least one group of users, wherein the dashboard for the user includes the at least one assigned educational cycle.

20. The computer system of claim 14, wherein the dashboard includes a list of coaches associated with the educational cycle and an indication of availability of the coach, wherein the server is configured to:
receive a selection of one of the coaches from the user; and
initiate a communication between the user and the coach based on the availability of the coach.

21. The computer system of claim 14, wherein the educational cycle is selected from a plurality of educational cycles based on an onboarding survey of the user, wherein each of the educational cycles is assigned a stage of development along a roadmap, and completion of an educational cycle allows access to an associated educational cycle in a next stage of development along the roadmap.
